(19) United States
(12) Patent Application Publication
(10) Pub. No.: US 2023/0107546 A1
(43) Pub. Date: Apr. 6, 2023

(54) CHANNEL STATE INFORMATION REPORT SCHEDULING

(71) Applicant: Lenovo (Singapore) PTE. LTD., New Tech Park (SG)

(72) Inventors: Prateek Basu Mallick, Dreieich (DE); Joachim Loehr, Wiesbaden (DE); Karthikeyan Ganesan, Kronberg im Taunus (DE); Ravi Kuchibhotla, Chicago, IL (US)

(21) Appl. No.: 17/906,301

(22) PCT Filed: Mar. 19, 2021
(86) PCT No.: PCT/IB2021/052336

§ 371 Date: Sep. 14, 2022

Related U.S. Application Data
(60) Provisional application No. 62/993,880, filed on Mar. 24, 2020.

(51) Int. Cl. H04L 5/00; H04W 72/04; H04W 72/12; H04B 7/06

(52) U.S. Cl. CPC H04L 5/0057; H04B 7/0626; H04W 72/0406; H04W 72/1278

(57) ABSTRACT

Apparatuses, methods, and systems are disclosed for channel state information report scheduling. One method (800) includes receiving (802) a channel state information request at a first time. The method (800) includes determining (804) whether a resource for transmitting a channel state information report is available prior to a second time. The method (800) includes, in response to determining that no resource for transmitting the channel state information report is available prior to the second time, triggering (806) a scheduling request to request a new resource for transmitting the channel state information report prior to the second time.

### CROSS-REFERENCE TO RELATED APPLICATIONS

This application claims priority to U.S. Pat. Application Serial No. 62/993,880 entitled “APPARATUSES, METHODS, AND SYSTEMS FOR OPTIMAL CSI REPORTING AND DATA TRANSMISSION ON SIDELINK” and filed on Mar. 24, 2020 for Prateek Basu Mallick, which is incorporated herein by reference in its entirety.

### FIELD

The subject matter disclosed herein relates generally to wireless communications and more particularly relates to channel state information report scheduling.

### BACKGROUND

In certain wireless communications networks, a trigger for a channel state information report may not occur with enough time for the channel state information report to be prepared.

### BRIEF SUMMARY

Methods for channel state information report scheduling are disclosed. Apparatuses and systems also perform the functions of the methods. One embodiment of a method includes receiving a channel state information request at a first time. In some embodiments, the method includes determining whether a resource for transmitting a channel state information report is available prior to a second time. In various embodiments, the method includes, in response to determining that no resource for transmitting the channel state information report is available prior to the second time, triggering a scheduling request to request a new resource for transmitting the channel state information report prior to the second time.

One apparatus for channel state information report scheduling includes a receiver that receives a channel state information request at a first time. In various embodiments, the apparatus includes a processor that: determines whether a resource for transmitting a channel state information report is available prior to a second time; and, in response to determining that no resource for transmitting the channel state information report is available prior to the second time, triggers a scheduling request to request a new resource for transmitting the channel state information report prior to the second time.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for channel state information report scheduling;

FIG. 2 is a schematic block diagram illustrating one embodiment of an apparatus that may be used for channel state information report scheduling;

FIG. 3 is a schematic block diagram illustrating one embodiment of an apparatus that may be used for channel state information report scheduling;

FIG. 4 is a timing diagram illustrating one embodiment of configured grants;

FIG. 5 is a flow chart diagram illustrating one embodiment of a method for resource allocation and selection;

FIG. 6 is a timing diagram illustrating another embodiment of configured grants;

FIG. 7 is a diagram illustrating one embodiment of a SL MAC PDU; and

FIG. 8 is a flow chart diagram illustrating one embodiment of a method for channel state information report scheduling.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

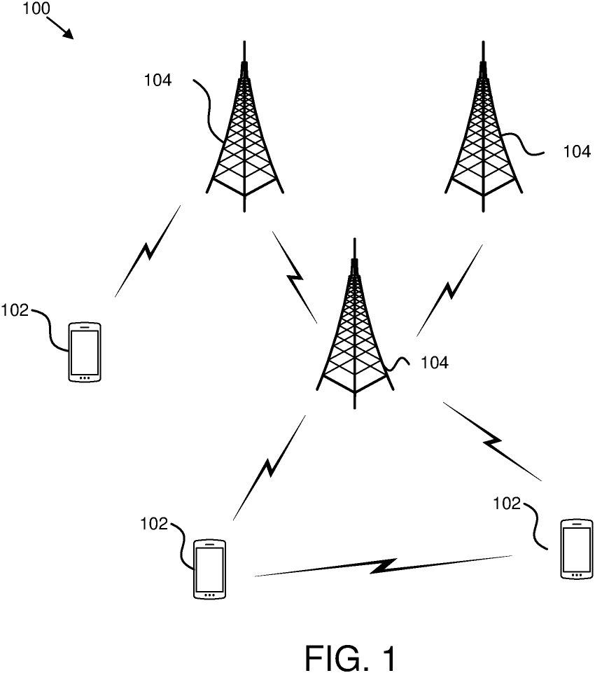

FIG. 1 depicts an embodiment of a wireless communication system 100 for channel state information report scheduling. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a channel state information request at a first time. In some embodiments, the remote unit 102 may determine whether a resource for transmitting a channel state information report is available prior to a second time. In various embodiments, the remote unit 102 may, in response to determining that no resource for transmitting the channel state information report is available prior to the second time, trigger a scheduling request to request a new resource for transmitting the channel state information report prior to the second time. Accordingly, the remote unit 102 may be used for channel state information report scheduling.

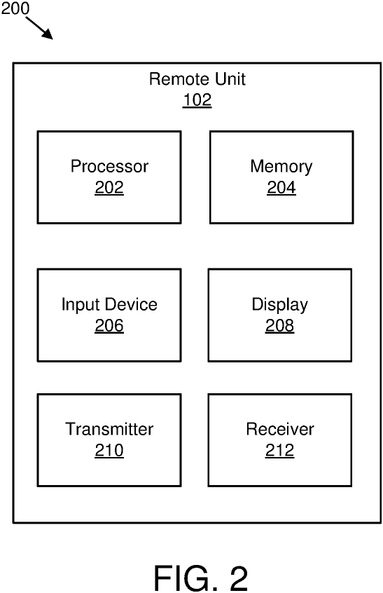

FIG. 2 depicts one embodiment of an apparatus 200 that may be used for channel state information report scheduling. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiment, the receiver 212 receives a channel state information request at a first time. In various embodiments, the processor 202: determines whether a resource for transmitting a channel state information report is available prior to a second time; and, in response to determining that no resource for transmitting the channel state information report is available prior to the second time, triggers a scheduling request to request a new resource for transmitting the channel state information report prior to the second time.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

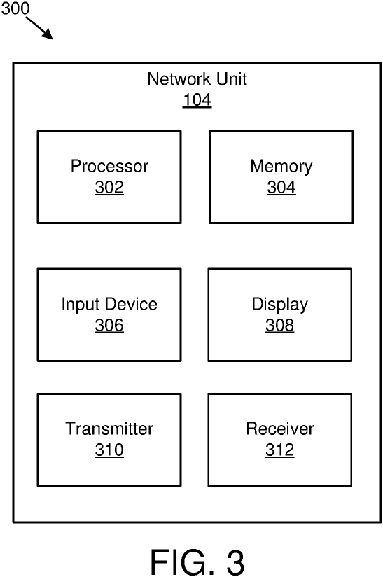

FIG. 3 depicts one embodiment of an apparatus 300 that may be used for channel state information report scheduling. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

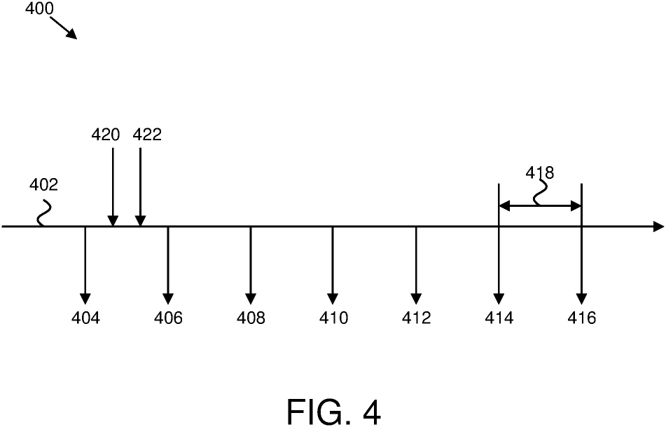

In certain embodiments, Type 1 or Type 2 configured grants may be available for mode 1 based sidelink transmission. In such embodiments, the periodicity of a configured grant (“CG”) occurrences may be longer than a 20 ms latency requirement for channel state information (“CSI”) reporting. Thus, it may be unclear how the latency requirement may be met. In some embodiments, such as like embodiments similar to those illustrated in FIG. 4, there may be CSI reporting triggered for more than 1 destination. Since only 1 grant may be used for CSI reporting for one destination, other destinations for CSI reporting may be pending and may need for more than one cycle of CG periodicity, thereby potentially missing a latency requirement.

FIG. 4 is a timing diagram 400 illustrating one embodiment of configured grants over a time period 402. Configured grants 404, 406, 408, 410, 412, 414, and 416 are scheduled to occur every 20 ms 418. In one example, a first CSI reporting trigger 420 (D1) is received and a second CSI reporting trigger 422 (D2) is received. The CSI report corresponding to D1 may be sent in the configured grant 406, but the CSI report for D2 must wait until the configured grant 408. The time from D2 to the configured grant 408 may exceed a required latency for CSI reporting.

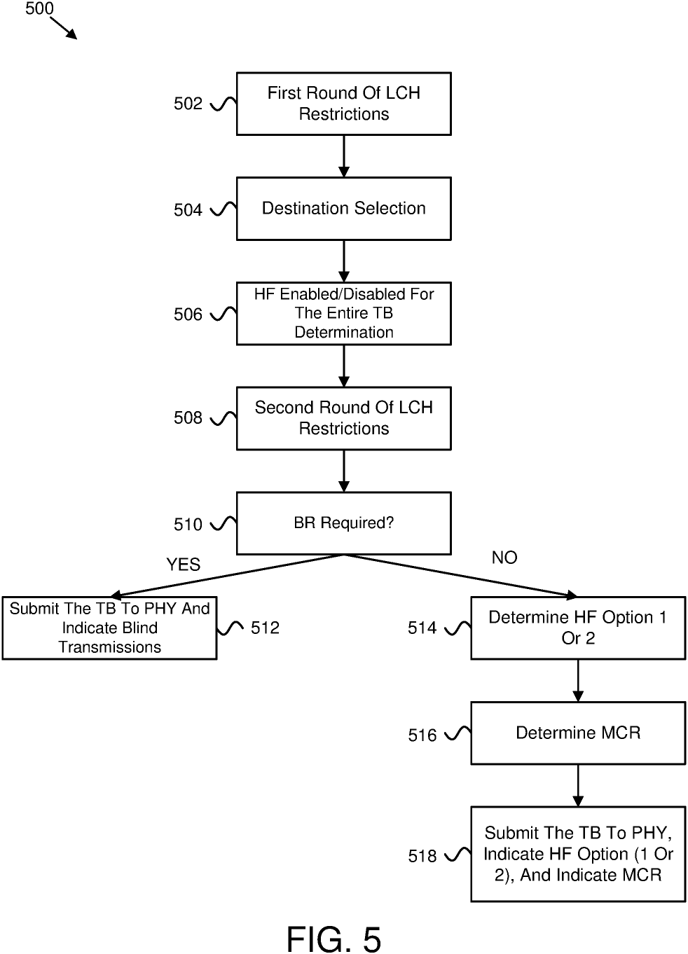

In certain embodiments, to perform resource allocation, a UE may select a sidelink destination. In such embodiments, the sidelink destination may be selected based on criteria that depend on a logical channel that has highest priority data available for transmission across all destinations as described in relation to FIG. 5.

FIG. 5 is a flow chart diagram illustrating one embodiment of a method 500 for resource allocation and selection. The method 500 includes performing 502 a first round of logical channel (“LCH”) restrictions. Furthermore, the method 500 includes selecting 504 a destination. Moreover, the method 500 includes determining 506 whether HARQ feedback (“HF”) is enabled and/or disabled for an entire transport block (“TB”). The method 500 includes performing 508 a second round of LCH restrictions. Furthermore, the method 500 includes determining 510 whether blind retransmission (“BR”) is required. In response to BR being required, the method 500 includes submitting 512 the TB to a physical (“PHY”) layer and indicating blind transmissions. Moreover, in response to BRnot being required, the method 500 includes determining 514 whether HF option 1 or option 2 is used. The method 500 then determines 516 a minimum communication range (“MCR”). Furthermore, the method 500 includes submitting 518 the TB to the PHY layer, indicating HF option 1 or option 2, and indicating the MCR.

In some embodiments, there may be more than one destination with either data and/or a CSI report. A selected destination with a CSI report may be selected for transmission even if a priority of data in other destinations is higher (e.g., lower value) than the priority of the data in the selected destination. In various embodiments, padding may be performed for a selected destination if there is only a CSI report for transmission (e.g., no data), a grant size is much bigger, and there is sufficient data in the other (e.g., not selected) destinations. In certain embodiments, there may be an optimization for allocating resources for data and/or CSI reporting.

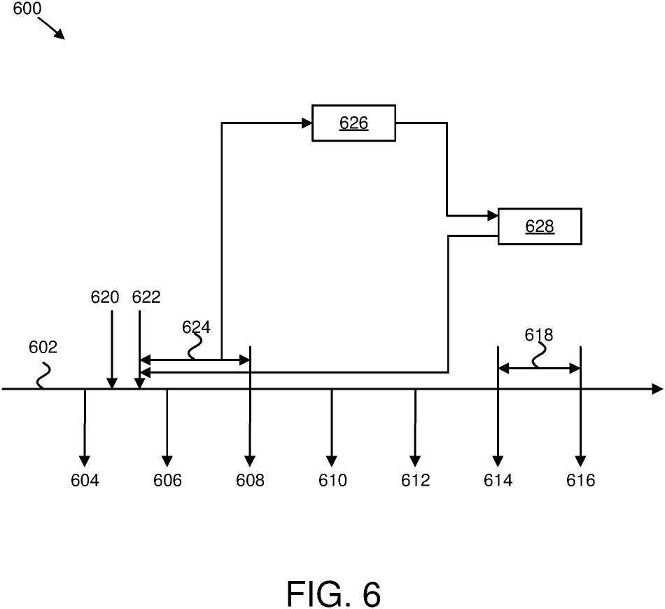

In various embodiments, a trigger (e.g., new trigger) for sidelink (“SL”) CSI specific scheduling request (“SR”) may be used. The SR may be triggered if a next grant is available (e.g., CG), but is too far away in time (e.g., a 20 ms delay for CSI reporting might be exceeded while attempting to transmit the CSI report successfully). A successful transmission of a CSI report may require more than a single transmission of the CSI report. In some embodiments, a UE may determine whether an available grant enables meeting a latency requirement (e.g., a 20 ms latency) for one or more retransmissions. If an available grant does not enable meeting the latency requirement, the SR may be triggered as shown in FIG. 6. In certain embodiments, an actual number of hybrid automatic repeat request (“HARQ”) transmissions and/or retransmissions required may be based on a HARQ operating point between the two UEs, a referenced signal received power (“RSRP”), and/or any other radio measurements that may be available.

In some embodiments, a threshold (e.g., in terms of a maximum time) may be configured for SL CSI reporting. The threshold may be used to determine whether a SL SR should be triggered. The SR may be triggered if either no SL-SCH resource is allocated or if the allocated SL-SCH resource is more than the threshold ahead from a time point in which SL CSI reporting has been triggered.

In various embodiments, a SR for SL CSI report and/or medium access control (“MAC”) control element (“CE”) may be triggered if a UE has SL resources allocated for new transmission which are later than a next physical uplink control channel (“PUCCH”) transmission occasion of the SR configuration for the SL CSI.

In some embodiments, a SL MAC CE (e.g., SL CSI) may be configured with PC5 restriction parameters (e.g., maxPSSCHduration, allowedSCS, etc.). In certain embodiments, NR vehicle to everything (“V2X”) may support multiple subcarrier spacing (“SCS”). In certain embodiments, if SL and/or physical sidelink shared channel (“PSSCH”) resources are available for a new transmission which does not meet logical channel prioritization (“LCP”) mapping restrictions configured for a SL CSI, a UE may trigger a SR.

FIG. 6 is a timing diagram 600 illustrating another embodiment of configured grants over a time period 602. Configured grants 604, 606, 608, 610, 612, 614, and 616 are scheduled to occur every 20 ms 618. In one example, a first CSI reporting trigger 620 (D1) is received and a second CSI reporting trigger 622 (D2) is received. The CSI report corresponding to D1 may be sent in the configured grant 606, but the CSI report for D2 must wait until the configured grant 608. The time from D2 to the configured grant 608 may exceed a required latency for CSI reporting. Accordingly, it is detected 626 that there is a CSI reporting opportunity more than the latency time away (e.g., 20 ms). Thus, a SR is triggered 628 to provide a new transmission opportunity for a CSI report.

In various embodiments, transmissions of CSI reports and data may be balanced and/or efficient.

In some embodiments, a gNB may decide what needs to be transmitted and may indicate what needs to be transmitted in a Mode 1 SL grant. In certain embodiments, an explicit indication in a Mode 1 SL grant may indicate if only a CSI report is to be transmitted, if MAC CEs should be included, if only data of SL logical channels should be included, or if both CSI reports or MAC CEs and data of SL LCHs for the same destination should be included. Such embodiments may ensure that UEs are implemented in the same way and that a network knows if data and/or a CSI report has been transmitted and whether the UE can provide further grants for remaining data and/or CSI reports.

In various embodiments, a new SR trigger may be used such that a SR is triggered if the SL shared channel (“SCH”) resource cannot include a CSI report (e.g., due to a new restriction in a downlink control information (“DCI”) grant or if a SL MAC CE such as SL CSI is configured with PC5 restriction parameters (e.g., maxPSSCHduration, allowedSCS)).

In some embodiments, a UE autonomously prioritizes a CSI report for a destination to ensure that reporting is done within 20 ms while maximizing data transmission. This may be done using different implementations.

In certain embodiments, Mode 1 LCP, without considering CSI reporting related MAC CEs (e.g., for logical channels), may be performed until a last transmission opportunity (e.g., in case of CG) that still allows for a timely transmission of a CSI report (e.g., even considering one or more retransmissions of the CSI report).

In various embodiments, Mode 1 LCP without considering CSI reporting may be performed and CSI reporting may be done using a Mode 2 based transmission if high priority data needs to be quickly transmitted.

In some embodiments, a CG only for CSI reporting may be used. This CG may be used for CSI reporting if a CSI report is available for transmission, and, if a CSI report is not available for transmission, data may be transmitted.

In certain embodiments, a receiver UE (e.g., the transmitter of a CSI report) may maximize data transmission by assigning a priority lower than 1 to a CSI report. The priority that is selected may be left to UE implementation, configured by a network, received from upper layers, and/or be preconfigured. In various embodiments, the priority may correspond to an importance of a transmitter UE for which a CSI is to be reported by a receiver UE, a priority of transmitter UE for which the CSI is to be reported by the receiver UE, or a V2X or sidelink application active between two UEs.

In some embodiments, a MAC CE containing a channel quality indicator (“CQI”) and/or CSI report (e.g., also referred to as SL CSI reporting MAC CE) may include a source identifier and a destination identifier. In certain embodiments, a source (“SRC”) field for a source layer 2 (“Layer-2”) identifier (“ID”), carries the 16 most significant bits of a source Layer-2 ID field (e.g., of a UE transmitting the CSI Report) and a destination (“DST”) field may carry the 8 most significant bits of the Layer-2 ID of an intended recipient (e.g., a UE that triggered (e.g., solicited) the CSI report (e.g., identifying which link and/or source the CSI refers to). In various embodiments, including a source-DST identifier pair in a MAC SL MAC CE may enable multiplexing a CSI MAC CE in a TB that is primarily addressed to another destination ID. In such embodiments, an SRC (e.g., source identifier) may be contained only once in an entire TB (e.g., only as part of a SL-SCH MAC subheader).

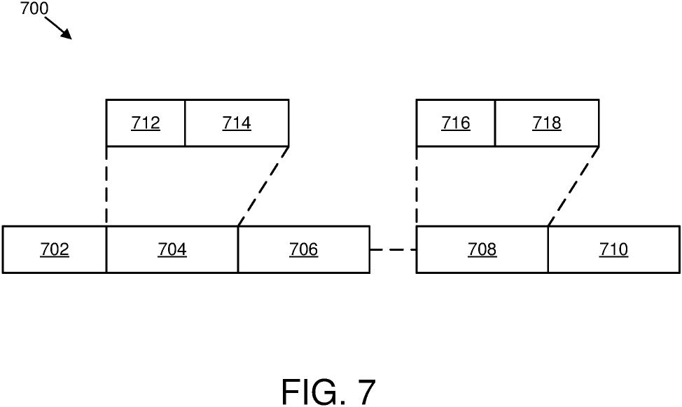

FIG. 7 is a diagram illustrating one embodiment of a SL MAC protocol data unit (“PDU”) 700. The SL MAC PDU 700 includes a SL-SCH subheader 702, a MAC subPDU including MAC service data unit (“SDU”) 704, a MAC subPDU including MAC SDU 706 (e.g., and additional MAC subPDUs including MAC SDU), a MAC subPDU including MAC CE 708, and an optional MAC subPDU including padding 710. The MAC subPDU including MAC SDU 704 includes an R/F/logical channel identifier (“LCID”)/L subheader 712 and a MAC SDU 714 (e.g., each MAC subPDU including MAC SDU may include an R/F/LCID/L subheader 712 and a MAC SDU 714). The MAC subPDU including MAC CE 708 includes an R/LCID subheader 716 and a MAC CE 718. In some embodiments, instead of a R/LCID pair for a MAC PDU, a R/LCID/DST or R/LCID/SRC/DST may be included.

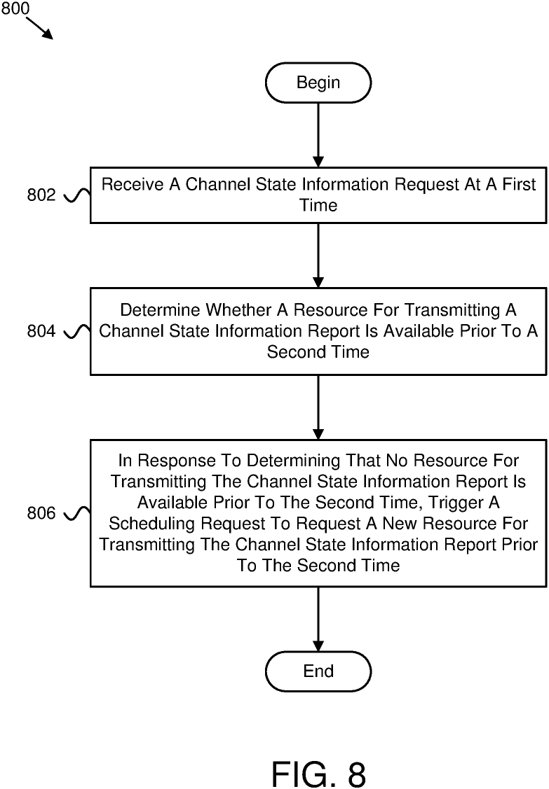

FIG. 8 is a flow chart diagram illustrating one embodiment of a method 800 for channel state information report scheduling. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 a channel state information request at a first time. In some embodiments, the method 800 includes determining 804 whether a resource for transmitting a channel state information report is available prior to a second time. In various embodiments, the method 800 includes, in response to determining that no resource for transmitting the channel state information report is available prior to the second time, triggering 806 a scheduling request to request a new resource for transmitting the channel state information report prior to the second time.

In certain embodiments, the channel state information report is transmitted using a medium access control control element. In some embodiments, the method 800 further comprises transmitting the scheduling request to request the new resource for transmitting the channel state information report prior to the second time. In various embodiments, the new resource comprises a sidelink shared channel resource.

In one embodiment, determining that no resource for transmitting the channel state information report is available prior to the second time comprises determining that there are no sidelink shared channel resources allocated for accommodating a sidelink channel state information reporting medium access control control element and a subheader corresponding to the medium access control control element. In certain embodiments, the method 800 further comprises identifying a maximum time to respond to the channel state information request. In some embodiments, the second time occurs the maximum time after the first time.

In various embodiments, the second time comprises a time of a next physical uplink control channel transmission occasion of a scheduling resource configuration for sidelink channel state information, and sidelink resources are allocated for a new transmission later than the second time. In one embodiment, the method 800 further comprises, in response to determining that a resource for transmitting the channel state information report, the medium access control control element, or the combination thereof is available prior to the second time, triggering a scheduling request to request a new resource for transmitting the channel state information report, the medium access control control element, or the combination thereof in response to a sidelink logical channel restriction parameter. In certain embodiments, the sidelink restriction parameter comprises a device to device communication interface (“PC5”) logical channel restriction parameter.

In one embodiment, a method comprises: receiving a channel state information request at a first time; determining whether a resource for transmitting a channel state information report is available prior to a second time; and, in response to determining that no resource for transmitting the channel state information report is available prior to the second time, triggering a scheduling request to request a new resource for transmitting the channel state information report prior to the second time.

In certain embodiments, the channel state information report is transmitted using a medium access control control element.

In some embodiments, the method further comprises transmitting the scheduling request to request the new resource for transmitting the channel state information report prior to the second time.

In various embodiments, the new resource comprises a sidelink shared channel resource.

In one embodiment, determining that no resource for transmitting the channel state information report is available prior to the second time comprises determining that there are no sidelink shared channel resources allocated for accommodating a sidelink channel state information reporting medium access control control element and a subheader corresponding to the medium access control control element.

In certain embodiments, the method further comprises identifying a maximum time to respond to the channel state information request.

In some embodiments, the second time occurs the maximum time after the first time.

In various embodiments, the second time comprises a time of a next physical uplink control channel transmission occasion of a scheduling resource configuration for sidelink channel state information, and sidelink resources are allocated for a new transmission later than the second time.

In one embodiment, the method further comprises, in response to determining that a resource for transmitting the channel state information report, the medium access control control element, or the combination thereof is available prior to the second time, triggering a scheduling request to request a new resource for transmitting the channel state information report, the medium access control control element, or the combination thereof in response to a sidelink logical channel restriction parameter.

In certain embodiments, the sidelink restriction parameter comprises a PC5 logical channel restriction parameter.

In one embodiment, an apparatus comprising: a receiver that receives a channel state information request at a first time; and a processor that: determines whether a resource for transmitting a channel state information report is available prior to a second time; and, in response to determining that no resource for transmitting the channel state information report is available prior to the second time, triggers a scheduling request to request a new resource for transmitting the channel state information report prior to the second time.

In certain embodiments, the channel state information report is transmitted using a medium access control control element.

In some embodiments, the apparatus further comprises a transmitter that transmits the scheduling request to request the new resource for transmitting the channel state information report prior to the second time.

In various embodiments, the new resource comprises a sidelink shared channel resource.

In one embodiment, the processor determining that no resource for transmitting the channel state information report is available prior to the second time comprises the processor determining that there are no sidelink shared channel resources allocated for accommodating a sidelink channel state information reporting medium access control control element and a subheader corresponding to the medium access control control element.

In certain embodiments, the processor identifies a maximum time to respond to the channel state information request.

In some embodiments, the second time occurs the maximum time after the first time.

In various embodiments, the second time comprises a time of a next physical uplink control channel transmission occasion of a scheduling resource configuration for sidelink channel state information, and sidelink resources are allocated for a new transmission later than the second time.

In one embodiment, the processor, in response to determining that a resource for transmitting the channel state information report, the medium access control control element, or the combination thereof is available prior to the second time, triggers a scheduling request to request a new resource for transmitting the channel state information report, the medium access control control element, or the combination thereof in response to a sidelink logical channel restriction parameter.

In certain embodiments, the sidelink restriction parameter comprises a PC5 logical channel restriction parameter.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving a channel state information request at a first time;
determining whether a resource for transmitting a channel state information report is available prior to a second time; and
in response to determining that no resource for transmitting the channel state information report is available prior to the second time, triggering a scheduling request to request a new resource for transmitting the channel state information report prior to the second time.

2. The method of claim 1, wherein the channel state information report is transmitted using a medium access control control element.

3. The method of claim 1, further comprising transmitting the scheduling request to request the new resource for transmitting the channel state information report prior to the second time.

4. The method of claim 1, wherein the new resource comprises a sidelink shared channel resource.

5. The method of claim 1, wherein determining that no resource for transmitting the channel state information report is available prior to the second time comprises determining that there are no sidelink shared channel resources allocated for accommodating a sidelink channel state information reporting medium access control control element and a subheader corresponding to the medium access control control element.

6. The method of claim 1, further comprising identifying a maximum time to respond to the channel state information request.

7. The method of claim 6, wherein the second time occurs the maximum time after the first time.

8. The method of claim 1, wherein the second time comprises a time of a next physical uplink control channel transmission occasion of a scheduling resource configuration for sidelink channel state information, and sidelink resources are allocated for a new transmission later than the second time.

9. The method of claim 1, further comprising, in response to determining that a resource for transmitting the channel state information report, the medium access control control element, or the combination thereof is available prior to the second time, triggering a scheduling request to request a new resource for transmitting the channel state information report, the medium access control control element, or the combination thereof in response to a sidelink logical channel restriction parameter.

10. The method of claim 1, wherein the sidelink restriction parameter comprises a PC5 logical channel restriction parameter.

11. An apparatus comprising:
a receiver that receives a channel state information request at a first time; and
a processor that:
determines whether a resource for transmitting a channel state information report is available prior to a second time; and
in response to determining that no resource for transmitting the channel state information report is available prior to the second time, triggers a scheduling request to request a new resource for transmitting the channel state information report prior to the second time.

12. The apparatus of claim 11, wherein the channel state information report is transmitted using a medium access control control element.

13. The apparatus of claim 11, further comprising a transmitter that transmits the scheduling request to request the new resource for transmitting the channel state information report prior to the second time.

14. The apparatus of claim 11, wherein the new resource comprises a sidelink shared channel resource.

15. The apparatus of claim 11, wherein the processor determining that no resource for transmitting the channel state information report is available prior to the second time comprises the processor determining that there are no sidelink shared channel resources allocated for accommodating a sidelink channel state information reporting medium access control control element and a subheader corresponding to the medium access control control element.

16. The apparatus of claim 11, wherein the processor identifies a maximum time to respond to the channel state information request.

17. The apparatus of claim 16, wherein the second time occurs the maximum time after the first time.

18. The apparatus of claim 11, wherein the second time comprises a time of a next physical uplink control channel transmission occasion of a scheduling resource configuration for sidelink channel state information, and sidelink resources are allocated for a new transmission later than the second time.

19. The apparatus of claim 11, wherein the processor, in response to determining that a resource for transmitting the channel state information report, the medium access control control element, or the combination thereof is available prior to the second time, triggers a scheduling request to request a new resource for transmitting the channel state information report, the medium access control control element, or the combination thereof in response to a sidelink logical channel restriction parameter.

20. The apparatus of claim 11, wherein the sidelink restriction parameter comprises a PC5 logical channel restriction parameter.
